(19) United States
(12) Patent Application Publication
(10) Pub. No.: US 2015/0211458 A1
(43) Pub. Date: Jul. 30, 2015

(54) TARGETING OF FUEL OUTPUT BY OFF-AXIS DIRECTING OF NOZZLE OUTPUT STREAMS

(71) Applicant: 3M INNOVATIVE PROPERTIES COMPANY, St. Paul, MN (US)

(72) Inventors: Barry S. Carpenter, Oakdale, MN (US); David H. Redinger, Afton, MN (US); Ryan C. Shirk, Mendota Heights, MN (US)

(21) Appl. No.: 14/417,340

(22) PCT Filed: Aug. 1, 2013
(86) PCT No.: PCT/US13/53141

§ 371 Date: Jan. 26, 2015

Related U.S. Application Data
(60) Provisional application No. 61/678,356, filed on Aug. 1, 2012.

(51) Int. Cl. F02M 57/04; F02M 61/18; F02M 61/14

(52) U.S. Cl. CPC F02M 57/04; F02M 61/145; F02M 61/18

(57) ABSTRACT

Nozzles and method of making the same are disclosed. The disclosed nozzles have a non-coined three-dimensional inlet face and an outlet face opposite the inlet face. The nozzles may have one or more nozzle through-holes extending from the inlet face to the outlet face. Fuel injectors containing the nozzle are also disclosed. Methods of making and using nozzles and fuel injectors are further disclosed.

### FIELD OF THE INVENTION

This invention generally relates to nozzles suitable for use in a fuel injector for an internal combustion engine. The invention is further applicable to fuel injectors incorporating such nozzles. This invention also relates to methods of making such nozzles, as well as methods of making fuel injectors incorporating such nozzles. The invention further relates to methods of using nozzles and fuel injectors in vehicles.

### BACKGROUND

There are three basic types of fuel injector systems. Those that use port fuel injection (PFI), gasoline direct injection (GDI), and direct injection (DI). While PFI and GDI use gasoline as the fuel, DI uses diesel fuel. Efforts continue to further develop fuel injector nozzles and fuel injection systems containing the same so as to potentially increase fuel efficiency and reduce hazardous emissions of internal combustion engines, as well as reduce the overall energy requirements of a vehicle comprising an internal combustion engine.

### SUMMARY OF THE INVENTION

The present invention is directed to fuel injector nozzles. In one exemplary embodiment, the fuel injector nozzle comprises: an inlet face; an outlet face opposite the inlet face; and a plurality of nozzle through-holes, with each nozzle through-hole comprising at least one inlet opening on the inlet face connected to at least one outlet opening on the outlet face by a cavity defined by an interior surface, the inlet opening being larger than the outlet opening, and the cavity being operatively adapted (i e , dimensioned, configured or otherwise designed) such that fuel flows out of the outlet opening at an acute or obtuse angle from the outlet face and toward at least one target location a desired distance from the outlet face.

The present invention is further directed to fuel injectors. In one exemplary embodiment, the fuel injector comprises any one of the herein-disclosed nozzles of the present invention.

The present invention is even further directed to fuel injector systems. In one exemplary embodiment, the fuel injector system comprises any one of the herein-disclosed nozzles or fuel injectors of the present invention. In some embodiments, the fuel injection system has a reduced SAC volume due to one or more inlet face features of a nozzle of the present invention extending into a ball valve outlet region of the fuel injector system.

The present invention is also directed to methods of making nozzles. In one exemplary embodiment, the method of making a nozzle of the present invention comprises making any of the herein-described nozzles.

The present invention is even further directed to methods of making fuel injectors. In one exemplary embodiment, the method of making a fuel injector comprises incorporating any one of the herein-described nozzles into the fuel injector.

The present invention is even further directed to methods of making fuel injection systems of a vehicle. In one exemplary embodiment, the method of making a fuel injection system of a vehicle comprises incorporating any one of the herein-described nozzles or fuel injectors into the fuel injection system. In some embodiments, the step of incorporating a nozzle or fuel injector of the present invention into the fuel injection system reduces a SAC volume of the fuel injection system.

The present invention is even further directed to methods of reducing a SAC volume of a fuel injection system of a vehicle. In one exemplary embodiment, the method of reducing a SAC volume of a fuel injection system of a vehicle comprises: incorporating a nozzle into the fuel injection system, wherein one or more inlet face features of the nozzle extend into a ball valve outlet region of a fuel injector system so as to reduce the SAC volume.

### BRIEF DESCRIPTION OF DRAWINGS

The invention may be more completely understood and appreciated in consideration of the following detailed description of various embodiments of the invention in connection with the accompanying drawings, in which:

FIG. 1 is a perspective view of an exemplary nozzle of the present invention;

FIG. 2 is a cross-sectional view of the exemplary nozzle shown in FIG. 1 along view 2-2 shown in FIG. 1;

FIGS. 3A-3B are views of an exemplary nozzle through-hole cavity of the exemplary nozzle shown in FIG. 1;

FIG. 4 is a top view of two arrays of nozzle through-hole cavities of another exemplary nozzle of the present invention;

FIG. 5 is a top view of four arrays of nozzle through-hole cavities of another exemplary nozzle of the present invention;

FIGS. 6A-6B are views of arrays of exemplary nozzle through-hole cavities of another exemplary nozzle of the present invention;

FIG. 7 is a cross-sectional view of another exemplary nozzle of the present invention;

FIG. 8 is a schematic of an exemplary fuel injector system of the present invention;

FIG. 9 is a cross-sectional view of an exemplary fuel injector of the present invention utilizing an exemplary nozzle of the present invention, wherein the nozzle comprises one or more inlet face features that reduce a SAC volume of the fuel injector system; and

FIG. 10 is a schematic of an exemplary fuel injection system of the present invention.

In the specification, a same reference numeral used in multiple figures refers to the same or similar elements having the same or similar properties and functionalities.

### DETAILED DESCRIPTION

The disclosed nozzles represent improvements to nozzles disclosed in (1) International Patent Application Publication WO2011/014607, which published on Feb. 03, 2011, and (2) International Patent Application Serial No. US2012/023624 (3M Docket No. 67266WO003 entitled “Nozzle and Method of Making Same”) filed on Feb. 2, 2012, the subject matter and disclosure of both of which are herein incorporated by reference in their entirety. The disclosed nozzles provide one or more advantages over prior nozzles as discussed herein. For example, the disclosed nozzles can advantageously be incorporated into fuel injector systems to improve fuel efficiency. The disclosed nozzles can be fabricated using multiphoton, such as two photon, processes like those disclosed in International Patent Application Publication WO2011/014607 and International Patent Application Serial No. US2012/023624. In particular, multiphoton processes can be used to fabricate various microstructures, which can at least include one or more hole forming features. Such hole forming features can, in turn, be used as molds to fabricate holes for use in nozzles or other applications.

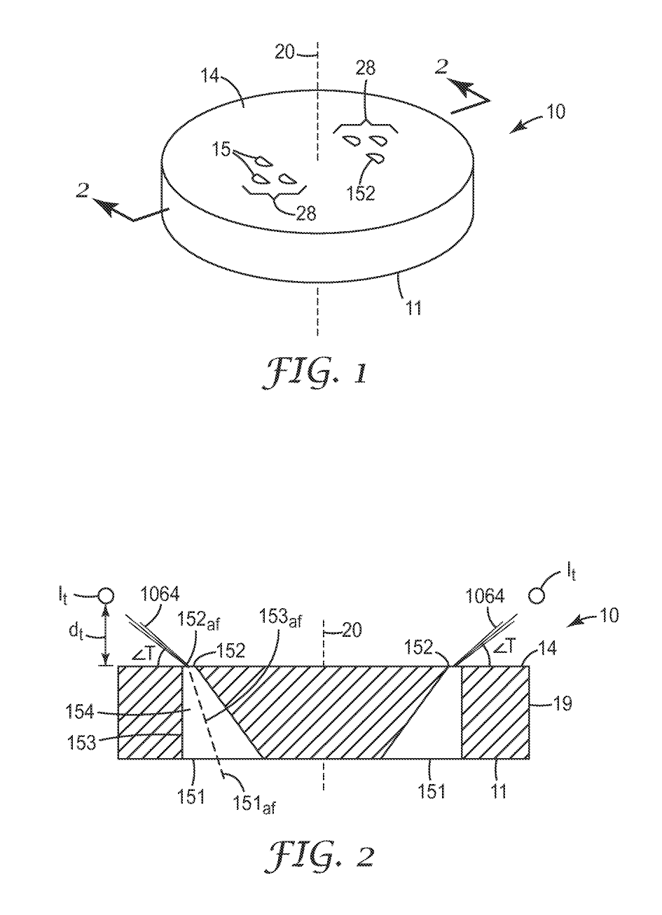

It should be understood that the term “nozzle” may have a number of different meanings in the art. In some specific references, the term nozzle has a broad definition. For example, U.S. Patent Publication No. 2009/0308953 A1 (Palestrant et al.), discloses an “atomizing nozzle” which includes a number of elements, including an occluder chamber 50. This differs from the understanding and definition of nozzle put forth herewith. For example, the nozzle of the current description would correspond generally to the orifice insert 24 of Palestrant et al. In general, the nozzle of the current description can be understood as the final tapered portion of an atomizing spray system from which the spray is ultimately emitted, see e.g., Merriam Webster's dictionary definition of nozzle (“a short tube with a taper or constriction used (as on a hose) to speed up or direct a flow of fluid.” Further understanding may be gained by reference to U.S. Pat. No. 5,716,009 (Ogihara et al.) issued to Nippondenso Co., Ltd. (Kariya, Japan). In this reference, again, fluid injection “nozzle” is defined broadly as the multi-piece valve element 10 (“fuel injection valve 10 acting as fluid injection nozzle . . .”—see col. 4, lines 26-27 of Ogihara et al.). The current definition and understanding of the term “nozzle” as used herein would relate, e.g., to first and second orifice plates 130 and 132 and potentially sleeve 138 (see FIGS. 14 and 15 of Ogihara et al.), for example, which are located immediately proximate the fuel spray. A similar understanding of the term “nozzle” to that described herein is used in U.S. Pat. No. 5,127,156 (Yokoyama et al.) to Hitachi, Ltd. (Ibaraki, Japan). There, the nozzle 10 is defined separately from elements of the attached and integrated structure, such as “swirler” 12 (see FIG. 1(II)). The above-defined understanding should be understood when the term “nozzle” is referred to throughout the remainder of the description and claims.

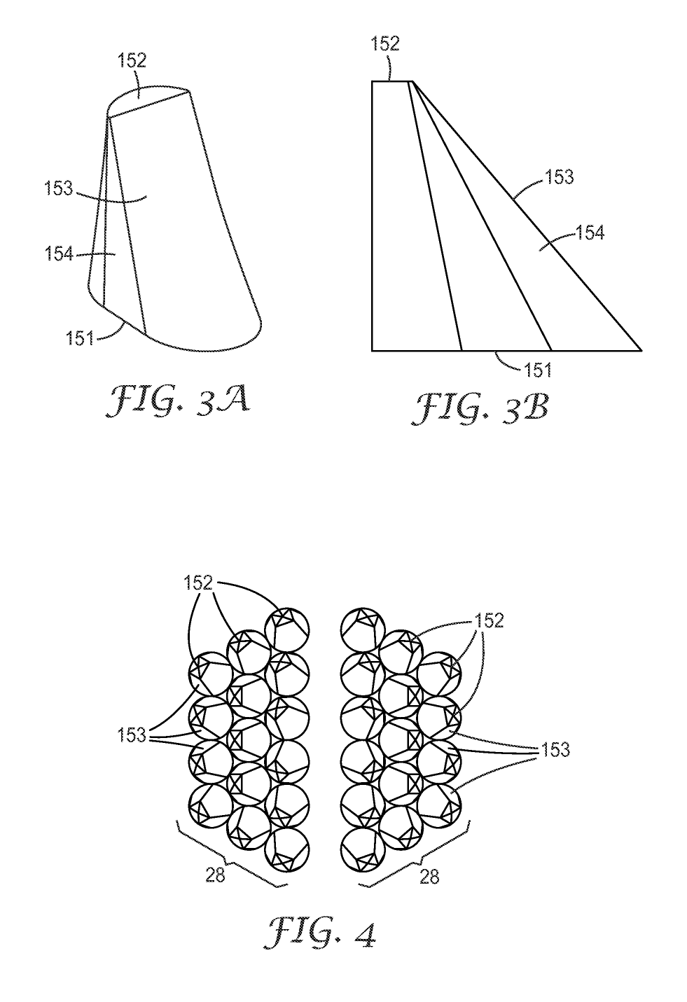

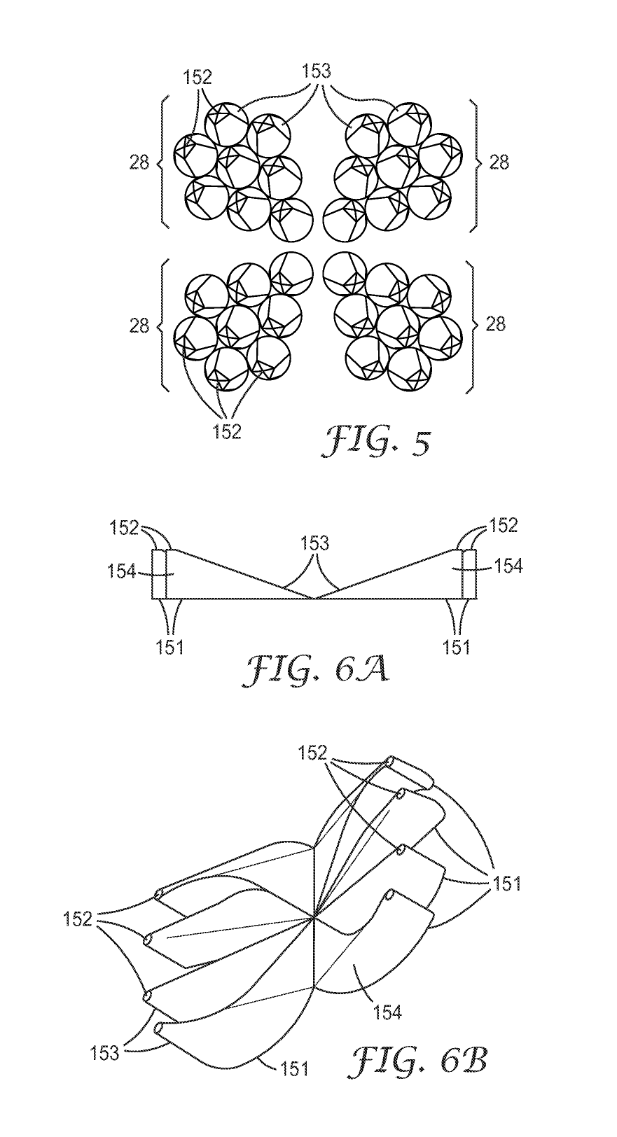

FIGS. 1-9 depict various nozzles 10 of the present invention. The disclosed nozzles 10 include an inlet face 11; an outlet face 14 opposite inlet face 11; and a plurality of nozzle through-holes 15 forming one or more arrays 28 of nozzle through-holes 15. Each nozzle through-hole 15 comprises at least one inlet opening 151 on inlet face 11 connected to at least one outlet opening 152 on outlet face 14 by a cavity 153 defined by an interior surface 154, with inlet opening 151 being larger than outlet opening 152, and cavity 153 being operatively adapted (i.e., dimensioned, configured or otherwise designed) such that fuel 1064 flows out of outlet opening 152 at an acute or obtuse angle T from (i.e., not perpendicular to) outlet face 14 and to or at least toward at least one target location lₜ (e.g., a space located) a desired distance dₜ from outlet face 14.

Nozzle through-holes 15 provide one or more of the following properties to the nozzle 10: (1) the ability to provide variable fluid flow through a single nozzle through-hole 15 or through multiple nozzle through-holes 15 (e.g., the combination of increased fluid flow through one or more outlet openings 152 and decreased fluid flow through other outlet openings 152 of the same nozzle through-hole 15 or of multiple nozzle through-holes 15) by selectively designing individual cavity passages (i.e., cavity passages 153′ discussed below) extending along a length of a given nozzle through-hole 15), (2) the ability to provide single- or multi-directional fluid flow relative to an outlet face 14 of the nozzle 10 via a single nozzle through-hole 15 or multiple nozzle through-holes 15, and (3) the ability to provide single- or multi-directional off-axis fluid flow relative to a central normal line 20 extending perpendicularly through the nozzle outlet face 14 via a single nozzle through-hole 15 or multiple nozzle through-holes 15.

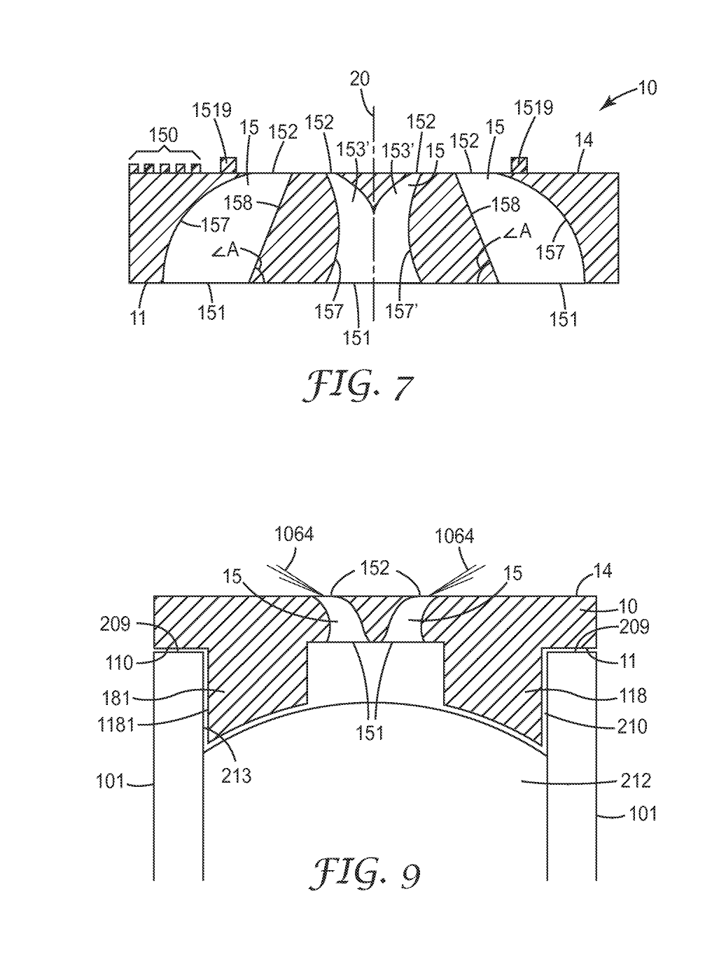

As shown in FIG. 7, exemplary nozzles 10 of the present invention may comprise a number of optional, additional features. Suitable optional, additional features include, but are not limited to, one or more anti-coking microstructures 150 positioned along any portion of outlet face 14, and one or more fluid impingement structures 1519 along any portion of outlet face 14.

As shown in FIGS. 1-9, nozzles 10 of the present invention may comprise nozzle through-holes 15, wherein each nozzle through-hole 15 independently comprises the following features: (i) one or more inlet openings 151, each of which has its own independent shape and size, (ii) one or more outlet openings 152, each of which has its own independent shape and size, (iii) an internal surface 154 profile that may include one or more curved sections 157, one or more linear sections 158, or a combination of one or more curved sections 157 and one or more linear sections 158, and (iv) an internal surface 154 profile that may include two or more cavity passages 153′ extending from multiple inlet openings 151 and merging into a single cavity passage 153′ extending to a single outlet opening 152, or a single cavity passages 153′ extending from a single inlet opening 151 and separating into two or more cavity passages 153′ extending to multiple outlet openings 152. Selection of these features for each independent nozzle through-hole 15 enables nozzle 10 to provide (1) substantially equal fluid flow through nozzle through-holes 15 (i.e., fluid flow that is essentially the same exiting each multiple outlet opening 152 of nozzle through-holes 15), (2) variable fluid flow through nozzle through-holes 15 (i.e., fluid flow that is not the same exiting the multiple outlet openings 152 of nozzle through-hole 15), (3) single- or multi-directional fluid streams exiting nozzle through-holes 15, (4) linear and/or curved fluid streams exiting nozzle through-holes 15, and (5) parallel and/or divergent and/or parallel followed by convergent fluid streams exiting nozzle through-holes 15.

As shown in FIG. 9, in some embodiments, nozzle 10 further comprises an inlet surface having one or more inlet face features 118 that extend into a ball valve outlet region 210 of a fuel injector 101 to reduce a SAC volume of the fuel injector 101 when nozzle 10 is placed in contact with or proximate a ball valve 212 outlet (also referred to herein as fuel injector tip 209). One or more inlet face features 118 may comprise a tubular-shaped member 118 having an outer circular side wall 1181 that abuts or is positioned adjacent to an inner side wall surface 213 of the ball valve outlet region 210 as shown in FIG. 9. It can be desirable, in addition or alternatively, for the inlet surface of the nozzle to match, preferably so as to mate and/or seal with, the outer surface of the ball valve.

The disclosed nozzles 10 may comprise (or consist essentially of or consist of) any one of the disclosed nozzle features or any combination of two or more of the disclosed nozzle features. In addition, although not shown in the figures and/or described in detail herein, the nozzles 10 of the present invention may further comprise one or more nozzle features disclosed in (1) U.S. Provisional Patent Application Ser. No. 61/678,475 (3M Docket No. 69909US002 entitled “GDI Fuel Injectors with Non-Coined Three-Dimensional Nozzle Outlet Face”) filed on Aug. 01, 2012, (2) U.S. Provisional Patent Application Ser. No. 61/678,330 (3M Docket No. 69911US002 entitled “Fuel Injector Nozzles with at Least One Multiple Inlet Port and/or Multiple Outlet Port”) filed on Aug. 01, 2012, (3) U.S. Provisional Patent Application Ser. No. 61/678,305 (3M Docket No. 69912US002 entitled “Fuel Injectors with Improved Coefficient of Fuel Discharge”) filed on Aug. 01, 2012, and (4) U.S. Provisional Patent Application Ser. No. 61/678,288 (3M Docket No. 69913US002 entitled “Fuel Injectors with Non-Coined Three-dimensional Nozzle Inlet Face”) filed on Aug. 01, 2012, the subject matter and disclosure of each of which is herein incorporated by reference in its entirety.

The disclosed nozzles 10 may be formed using any method as long as the resulting inlet face 11 of the nozzle 10 has nozzle through-holes 15 as described herein. Although the methods of making nozzles 10 of the present invention are not limited to the methods disclosed in International Patent Application Serial No. US2012/023624, nozzles 10 of the present invention may be formed using the methods as disclosed in International Patent Application Serial No. US2012/023624. See, in particular, the method steps described in reference to FIGS. 1A-1M of International Patent Application Serial No. US2012/023624.

### Additional Embodiments

### Nozzle Embodiments

1. A fuel injector nozzle 10 comprising: an inlet face 11; an outlet face 14 opposite said inlet face 11; and a plurality of nozzle through-holes 15 forming one or more arrays 28 of nozzle through-holes 15, with each nozzle through-hole 15 comprising at least one inlet opening 151 on said inlet face 11 connected to at least one outlet opening 152 on said outlet face 14 by a cavity 153 defined by an interior surface 154, said inlet opening 151 being larger than said outlet opening 152, and said cavity 153 being operatively adapted (i.e., dimensioned, configured or otherwise designed) such that fuel 1064 flows out of said outlet opening 152 at an acute or obtuse angle T from (i.e., not perpendicular to) said outlet face 14 and to or at least toward at least one target location lₜ (e.g., a space located) a desired distance dₜ from said outlet face 14. In other words, at least one stream of fuel 1064 exits the nozzle through-hole 15 off-axis to the normal (i.e., central normal line 20) off of the nozzle outlet face 14.

2. The nozzle 10 of embodiment 1, wherein at least one said nozzle through-hole 15 has an inlet opening 151 axis of flow 151_{af}, a cavity 153 axis of flow 153_{af} and an outlet opening 152 axis of flow 152_{af}, and at least one axis of flow is different from at least one other axis of flow. The “axis of flow” is defined herein as the central axis of a stream of fuel as the fuel flows into, through or out of the nozzle through-hole 15. In the case of a nozzle through-hole 15 having multiple inlet openings 151, multiple outlet openings 152 or both, the nozzle through-hole 15 can have a different axis of flow 151_{af}/152_{af} corresponding to each of the multiple openings. See, for example, embodiment 6 below.

3. The nozzle 10 of embodiment 2, wherein said inlet opening 151 axis of flow 151_{af} is different from said outlet opening 152 axis of flow 152._{f}. See, for example, nozzle 10 in FIG. 7.

4. The nozzle 10 of embodiment 2 or 3, wherein each of said inlet opening 151 axis of flow 151_{af}, said cavity 153 axis of flow 153_{af} and said outlet opening 152 axis of flow 152_{af} are different. See, for example, nozzle 10 in FIG. 7. Examples of such differences may include, but are not be limited to, any combination of two or all three of the axes of flow (1) forming a different angle to outlet face 14, (2) not being aligned or parallel to each other, being aligned along different directions, being parallel but not aligned, intersecting but not being aligned, and any other conceivable geometric relationship two or three non-aligned line segments could have.

5. The nozzle 10 of any one of embodiments 1 to 4, wherein at least one said nozzle through-hole 15 has a cavity 153 that is operatively adapted (i.e., dimensioned, configured or otherwise designed) such that fuel flowing therethrough has an axis of flow that is curved. See, for example, nozzle 10 in FIG. 7.

6. The nozzle 10 of any one of embodiments 1 to 5, wherein at least one said nozzle through-hole 15 has multiple inlet openings 151, multiple outlet openings 152 or both, with an axis of flow corresponding to each of said multiple openings. See, for example, nozzle 10 in FIG. 7.

7. The nozzle 10 of embodiment 6, wherein at least two of said multiple openings 151/152 have a different corresponding axis of flow. See, for example, nozzle 10 in FIG. 7.

8. The nozzle 10 of embodiment 6 or 7, wherein each of said multiple openings 151/152 has a different corresponding axis of flow.

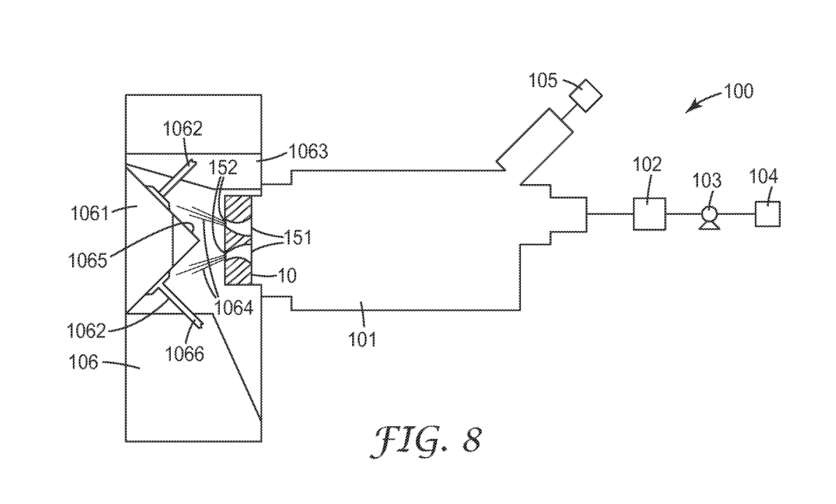

9. The nozzle 10 of any one of embodiments 1 to 8, wherein said nozzle through-holes 15 are operatively adapted (i.e., dimensioned, configured or otherwise designed) so that said at least one target location lₜ is an intake valve 1062 for a combustion chamber 1061 of an internal combustion engine 106. See, for example, internal combustion engine 106 in FIG. 8.

10. The nozzle 10 of embodiment 9, wherein said nozzle through-holes 15 are operatively adapted (i.e., dimensioned, configured or otherwise designed) so that said at least one target location lₜ is the stem side of the intake valve 1062.

11. The nozzle 10 of embodiment 9 or 10, wherein said nozzle through-holes 15 are operatively adapted (i.e., dimensioned, configured or otherwise designed) so that fuel 1064 flows out of at least one said outlet opening 152 and directly to an intake valve 1062 along at least a generally straight path.

12. The nozzle 10 of any one of embodiments 9 to 11, wherein said nozzle through-holes 15 are operatively adapted (i.e., dimensioned, configured or otherwise designed) so that said at least one target location lₜ is at least two intake valves 1062 for a combustion chamber 1061 of an internal combustion engine 106.

13. The nozzle 10 of embodiment 12, wherein the at least two intake valves 1062 are separated by at least one barrier 1065. That is, the nozzle through-holes 15 are operatively adapted (i.e., dimensioned, configured or otherwise designed) to direct fuel 1064 at each intake valve 1062 on opposite sides of at least one barrier 1065. See, for example, internal combustion engine 106 in FIG. 8.

14. The nozzle 10 of any one of embodiments 1 to 13, wherein said nozzle through-holes 15 are operatively adapted (i.e., dimensioned, configured or otherwise designed) so that fuel 1064 flows out of said nozzle 10 in the form of divergent, convergent or both divergent and convergent streams.

15. The nozzle 10 of embodiment 14, wherein the streams are symmetrical.

16. The nozzle 10 of any one of embodiments 1 to 15, wherein said nozzle through-holes 15 are operatively adapted (i.e., dimensioned, configured or otherwise designed) so that said at least one target location lₜ comprises multiple target locations lₜ. See, for example, nozzle 10 in FIG. 2.

17. The nozzle 10 of any one of embodiments 1 to 16, wherein said nozzle through-holes 15 are operatively adapted (i.e., dimensioned, configured or otherwise designed) so that fuel/fluid 1064 flows out of multiple outlet openings 152 to a single target location lₜ. For example, the fuel streams from multiple nozzle through-holes 152 can concentrate at, or focus to, a single target location lₜ.

18. The nozzle 10 of any one of embodiments 1 to 17, wherein said nozzle through-holes 15 define at least two arrays 28 of nozzle through-holes 15, and the nozzle through-holes 15 of each said array 28 are operatively adapted (i.e., dimensioned, configured or otherwise designed) so that fuel 1064 from each said array 28 flows to or at least toward a separate target location lₜ a desired distance dₜ from said outlet face 14. Typically, each array 28 comprises two or more nozzle through-holes 15, and can contain any number of nozzle through-holes 15. Further, each array 28 may comprise an identical number or a different number of nozzle through-holes 15, and there can be any number of arrays 28 within a given nozzle 10.

19. The nozzle 10 of embodiment 18, wherein said at least two arrays 28 of nozzle through-holes 15 are at least four arrays 28 of nozzle through-holes 15. It should be noted that there is no requirement that the arrays 28 be divided symmetrically.

20. The nozzle 10 of embodiment 18 or 19, wherein the nozzle through-holes 15 of each said array 28 are operatively adapted (i.e., dimensioned, configured or otherwise designed) so that fuel 1064 from the outlet openings 152 of each said array 28 flows to or at least toward a target location lₜ in the form of parallel non-converging fluid streams.

21. The nozzle 10 of embodiment 18 or 19, wherein the nozzle through-holes 15 of each said array 28 are operatively adapted (i.e., dimensioned, configured or otherwise designed) so that fuel 1064 from the outlet openings 152 of each said array 28 flows to or at least toward two separate target locations lₜ.

22. The nozzle 10 of embodiment 21, wherein fuel 1064 from at least two outlet openings 152 of each said array 28 flows to or at least toward one of the two separate target locations lₜ.

23. The nozzle 10 of any one of embodiments 1 to 22, wherein said inlet face 11 comprises a seating surface 110 for receiving so as to form a seal with a fuel injector valve 101, and when the fuel injector valve 101 forms a seal with said seating surface 110, a SAC volume is defined between said inlet face 11 and the fuel injector valve 101. “SAC volume” is a well known term that refers to a relatively small volume of space formed between the inlet face 11 of a fuel injector nozzle 10 that forms a seal with a leading surface of a fuel injector valve 212. Fuel can remain within this SAC volume during each combustion cycle of the corresponding combustion chamber of an internal combustion engine. Fuel remaining within the SAC volume can result in one or more detrimental effects including, but not limited to, “coking” or the pyrolysis of fuel to form carbonaceous deposits therein, distortion of fuel plume due to the inertial effect of the SAC volume as the injection event initiates and/or terminates, poorly defined droplet size (typically too large) that results from the emission of the SAC volume, and poor penetration of fuel streams. It is, therefore, desirable to eliminate or at least minimize the SAC volume. The present invention enables nozzle designs that can eliminate or at least minimize such SAC volumes. See, for example, embodiments 24-26.

24. The nozzle 10 of embodiment 23, wherein said inlet face 11 further comprises one or more inlet face features 118 that extend into a ball valve outlet region 210 of a fuel injector system 100 so as to reduce the SAC volume.

25. The nozzle 10 of embodiment 23 or 24, wherein the SAC volume is less than about 1.0 mm³ (or any volume less than 1.0 mm³ in increments of 0.1 mm³, or any range of volume values less than 1.0 mm³ and more than 0, in increments of 0.1 mm³).

26. The nozzle 10 of any one of embodiments 23 to 25, wherein the SAC volume is less than about 0.3 mm³ (or any volume less than 0.3 mm³ in increments of 0.1 mm³, or any range of volume values less than 0.3 mm³ and more than 0, in increments of 0.01 mm³).

27. The nozzle 10 of any one of embodiments 1 to 26, wherein each nozzle through-hole 15 has a curved surface profile (i.e., comprising an internal surface curved section 157; see, nozzle 10 in FIG. 7) directly extending along its interior surface 154 from its at least one inlet opening 151 to its at least one outlet opening 152.

28. The nozzle 10 of embodiment 27, wherein said curved surface profile has a radius of curvature of at least 10 μm (or any radius of curvature up to about 4 meters (m), or any value or range of values between 10 μm and 4 m, in increments of 1.0 μm) along at least a portion thereof.

29. The nozzle 10 of embodiment 27, wherein said curved surface profile has a radius of curvature in the range of from about 10 μm to about 4.0 m (or any radius of curvature up to about 4 m, or any value or range of values between 10 μm and 4 m, in increments of 1.0 μm) along at least a portion thereof.

30. The nozzle 10 of any one of embodiments 27 to 29, wherein the curved surface profile of each nozzle through-hole 15 extends a direct distance that is the shortest along its interior surface 154 from its at least one inlet opening 151 to its at least one outlet opening 152.

31. The nozzle 10 of any one of embodiments 27 to 29, wherein the curved surface profile of each nozzle through-hole 15 extends a direct distance that is the longest along its interior surface 154 from its at least one inlet opening 151 to its at least one outlet opening 152.

32. The nozzle 10 of any one of embodiments 27 to 29, wherein opposite side surfaces of said cavity 153 along said interior surface 153 comprise (i) a first curved interior surface portion 157 having a convex shape and (ii) a second curved interior surface portion 157 having a concave shape. See, for example, the nozzle through-holes 15 in nozzle 10 of FIG. 9.

33. The nozzle 10 of any one of embodiments 18 to 32, wherein each array 28 has an equal number of nozzle through-holes 15.

34. The nozzle 10 of any one of embodiments 18 to 32, wherein when two or more arrays 28 are present, at least two arrays 28 have a different number of nozzle through-holes 15.

35. The nozzle 10 of any one of embodiments 18 to 34, wherein at least two nozzle through-holes 15 within each array 28 of nozzle through-holes 15 have an interior surface profile that differs from one another.

36. The nozzle 10 of any one of embodiments 1 to 35, wherein said cavity 153 for a given nozzle through-hole 15 has a geometrically asymmetrical outline shape when viewed normal to a plane bisecting said at least one inlet opening 151 and said at least one outlet opening 152 for the given nozzle through-hole 15.

37. The nozzle 10 of any one of embodiments 1 to 36, wherein said at least one inlet opening 151 and said at least one outlet opening 152 for at least one nozzle through-hole 15 have a similar shape.

38. The nozzle 10 of any one of embodiments 1 to 37, wherein said at least one inlet opening 151 and said at least one outlet opening 152 for at least one nozzle through-hole 15 have a different shape.

39. The nozzle 10 of any one of embodiments 1 to 38, wherein said nozzle 10 has a nozzle thickness, nₜ, said at least one inlet opening 151 has an average inlet opening major axis (i.e., the largest dimension of the inlet opening 151), D, and said nozzle 10 has a ratio of said nozzle thickness to said average inlet opening major axis ranging from about 0.6:1 to 60:1 (or any ratio or ratio range therebetween in increments of 0.1 to 0.1), and more preferably from about 0.6:1 to 6:1.

40. The nozzle 10 of any one of embodiments 1 to 39, wherein said nozzle 10 has a nozzle thickness, nₜ, said at least one outlet opening 152 has an average outlet opening major axis (i.e., the largest dimension of the outlet opening), d, and said nozzle 10 has a ratio of said nozzle thickness to said average outlet opening major axis ranging from about 0.5:1 to 300:1 (or any ratio or ratio range therebetween in increments of 0.1 to 0.1) and more preferably 0.5:1 to about 150:1.

41. The nozzle 10 of any one of embodiments 1 to 40, wherein said nozzle 10 has an overall ratio of inlet opening 151 cross-sectional area to outlet opening 152 cross-sectional area for said plurality of nozzle through-holes 15 ranging from greater than 1.0 to about 2500 (or any overall ratio or overall ratio range therebetween in increments of 0.1).

42. The nozzle 10 of any one of embodiments 1 to 41, wherein said nozzle 10 has an overall ratio of inlet opening 151 cross-sectional area to outlet opening 152 cross-sectional area for said plurality of nozzle through-holes 15 ranging from about 2 to about 22 (or any overall ratio or overall ratio range therebetween in increments of 0.1).

43. The nozzle 10 of any one of embodiments 1 to 42, wherein said nozzle 10 has an overall ratio of inlet opening 151 cross-sectional area to outlet opening 152 cross-sectional area for said plurality of nozzle through-holes 15 ranging from about 4 to about 12 (or any overall ratio or overall ratio range therebetween in increments of 0.1).

44. The nozzle 10 of any one of embodiments 1 to 40, wherein said nozzle 10 has an overall ratio of inlet opening 151 cross-sectional area to outlet opening 152 cross-sectional area for said plurality of nozzle through-holes 15 of greater than 30 (or any overall ratio greater than 30 and up to about 2500 and any range therebetween, in increments of 0.1).

45. The nozzle 10 of any one of embodiments 1 to 40 and 44, wherein said nozzle 10 has an overall ratio of inlet opening 151 cross-sectional area to outlet opening 152 cross-sectional area for said plurality of nozzle through-holes 15 ranging from about 40 to about 250 (or any overall ratio or overall ratio range therebetween in increments of 0.1).

46. The nozzle 10 of any one of embodiments 1 to 45, wherein each target location lₜ (i) is positioned a distance dₜ of from about 0.1 mm to about 300 mm (or from about 5.0 mm to about 150 mm; or from about 10 mm to about 140 mm; or any distance between 0.1 mm and 300 mm or range therebetween, in increments of 0.1 mm) from said outlet face 14, and (ii) has a target area of less than about 10,000 mm² (or any area less than 10,000 mm² in increments of 1 mm² down to about 8 mm², or any range therebetween); and said plurality of nozzle through-holes 15 directs at least 95 vol % of fluid exiting said nozzle through-holes 15 into the target area.

47. The nozzle 10 of any one of embodiments 1 to 46, wherein said plurality of nozzle through-holes 15 is arranged in a circular pattern with each nozzle through-hole 15 being substantially equally distanced from a nozzle central axis 20 extending perpendicularly through said outlet face 14.

48. The nozzle 10 of any one of embodiments 1 to 47, wherein at least a portion of said inlet face 11 and at least a portion of said outlet face 14 are substantially parallel with one another.

49. The nozzle 10 of any one of embodiments 1 to 48, wherein said nozzle 10 further comprises one or more outlet face features 150/1519 positioned along said outlet face 14. See, for example, nozzle 10 in FIG. 7.

50. The nozzle 10 of embodiment 49, wherein said one or more outlet face features 150/1519 comprise one or more anti-coking microstructures 150 positioned along said outer face 14.

51. The nozzle 10 of embodiment 49 or 50, wherein said one or more outlet face features 150/1519 comprise one or more fluid impingement members 1519 positioned along said outer face 14.

52. The nozzle 10 of any one of embodiments 1 to 51, wherein each inlet opening 151 has a diameter of less than about 400 microns (or less than about 300 microns, or less than about 200 microns, or less than about 160 microns, or less than about 100 microns) (or any diameter between about 10 microns and 400 microns in increments of 1.0 micron, e.g., 10, 11, 12 . . . 388, 389, 390, etc. microns).

53. The nozzle 10 of any one of embodiments 1 to 52, wherein each outlet opening 152 has a diameter of less than about 400 microns (or less than about 300 microns, or less than about 200 microns, or less than about 100 microns, or less than about 50 microns, or less than about 20 microns) (or any diameter between about 10 microns and 400 microns in increments of 1.0 micron, e.g., 10, 11, 12 . . . 388, 389, 390, etc. microns).

54. The nozzle 10 of any one of embodiments 1 to 53, wherein the nozzle 10 comprises a metallic material, an inorganic non-metallic material (e.g., a ceramic), or a combination thereof.

55. The nozzle 10 of any one of embodiments 1 to 54, wherein the nozzle 10 comprises a ceramic selected from the group comprising silica, zirconia, alumina, titania, or oxides of yttrium, strontium, barium, hafnium, niobium, tantalum, tungsten, bismuth, molybdenum, tin, zinc, lanthanide elements having atomic numbers ranging from 57 to 71, cerium and combinations thereof.

56. The nozzle 10 of any one of embodiments 1 to 55, wherein the nozzle 10 is a nozzle plate 10.

### Fuel Injector Embodiments:

57. A fuel injector 101 comprising the nozzle 10 of any one of embodiments 1 to 56.

### Fuel Injection System Embodiments:

58. A fuel injection system 100 of a vehicle 200 comprising the fuel injector 101 of embodiment 57.

59. The fuel injection system 100 of embodiment 58, said fuel injection system 100 having a reduced SAC volume, said reduced SAC volume being less than about 0.3 mm³.

### Internal Combustion Engine Embodiments:

60. An internal combustion engine 106 comprising: one or more intake valves 1062, each of which comprising an intake valve stem 1066; and the fuel injection system 100 of embodiment 58 or 59; wherein said nozzle 10 directs fuel 1064 at each intake valve stem 1066.

61. The internal combustion engine 106 of embodiment 60, wherein said internal combustion engine 106 comprises at least two intake valves 1062.

62. The internal combustion engine 106 of embodiment 61, wherein said at least two intake valves 1062 are separated by at least one barrier 1065.

63. The internal combustion engine 106 of embodiment 61 or 62, wherein said plurality of nozzle through-holes 15 directs fuel 1064 toward valve stems 1066 of said at least two intake valves 1062.

64. The internal combustion engine 106 of any one of embodiments 60 to 63, wherein said fuel injection system 106 comprises a Port Fuel Injection (PFI) fuel injection system.

### Methods of Making Nozzles Embodiments:

65. A method of making the nozzle 10 of any one of embodiments 1 to 56.

66. The method of embodiment 65, said method comprising: applying a nozzle-forming material over a nozzle forming microstructured pattern comprising a plurality of nozzle hole forming features; separating the nozzle-forming material from the nozzle forming microstructured pattern to provide a nozzle 10; and removing material, as needed, from the nozzle 10 to form the plurality of nozzle through-holes 15.

67. The method of embodiment 66, wherein the nozzle forming microstructured pattern further comprises one or more planar control cavity forming features.

68. The method of embodiment 66 or 67, further comprising: providing a microstructured mold pattern defining at least a portion of a mold and comprising a plurality of replica nozzle holes; and molding a first material onto the microstructured mold pattern so as to form the nozzle forming microstructured pattern.

69. The method of embodiment 68, wherein the microstructured mold pattern comprises at least one fluid channel feature connecting at least one replica nozzle hole to (a) at least one other replica nozzle hole, (b) a portion of the mold beyond the outer periphery of the microstructured mold pattern, or (c) both (a) and (b).

### Methods of Making Fuel Injectors Embodiments:

70. A method of forming a fuel injector 101, said method comprising incorporating the nozzle 10 of any one of embodiments 1 to 56 into the fuel injector 101.

### Methods of Making Fuel Injection Systems Embodiments:

71. A method of forming a fuel injection system 100 of a vehicle 200, said method comprising incorporating the nozzle 10 of any one of embodiments 1 to 56 into the fuel injection system 100.

72. A method of forming a fuel injection system 100 of a vehicle 200, the fuel injection system 100 having a reduced SAC volume, said method comprising incorporating the nozzle 10 of any one of embodiments 24 to 26 into the fuel injection system 100.

### Methods of Using Fuel Injector Nozzles Embodiments:

73. A method of reducing a SAC volume of a fuel injection system 100 of a vehicle 200, said method comprising incorporating the nozzle 10 of any one of embodiments 24 to 26 into the fuel injection system 100.

74. A method of reducing a SAC volume of a fuel injection system 100 of a vehicle 200, said method comprising incorporating a nozzle 10 into the fuel injection system 100, wherein one or more inlet face features 118 of the nozzle 10 extend into a ball valve outlet region 210 of a fuel injector system 100 so as to reduce the SAC volume.

75. The method of embodiment 74, wherein the nozzle 10 comprises one or more nozzle through-holes 15, with each nozzle through-hole 15 comprising an inlet opening 151 and an outlet opening 152 connected to the inlet opening 151 by a cavity 153 defined by an interior surface 154.

76. The method of any one of embodiments 71 to 75, wherein the fuel injection system 100 does not comprise a plenum or counter bore along an upper portion of a ball valve outlet region 210.

77. The method of any one of embodiments 71 to 76, wherein the fuel injection system 100 comprises two intake valves 1062 per cylinder 1063, and separate arrays 28 of nozzle through-holes 15 independently direct fluid towards the two intake valves 1062.

### Nozzle Pre-Form Embodiments

78. A nozzle pre-form suitable for forming the nozzle 10 of any one of embodiments 1 to 56. See, for example, other nozzle pre-forms and how the nozzle pre-forms are utilized to form nozzles in FIGS. 1A-1M and the description thereof in International Patent Application Serial No. US2012/023624.

### Microstructured Pattern Embodiments

79. A microstructured pattern suitable for forming the nozzle 10 of any one of embodiments 1 to 56. See, for example, other microstructured patterns and how the microstructured patterns are utilized to form nozzles in FIGS. 1A-1M and the description thereof in International Patent Application Serial No. US2012/023624.

In any of the above embodiments, nozzle 10 may comprise a nozzle plate 10 having a substantially flat configuration typically with at least a portion of inlet face 11 substantially parallel to at least a portion of outlet face 14.

Desirably, nozzles 10 of the present invention each independently comprise a monolithic structure. As used herein, the term “monolithic” refers to a nozzle having a single, integrally formed structure, as oppose to multiple parts or components being combined with one another to form a nozzle.

It can be desirable for the thickness of a fuel injector nozzle 10 to be at least about 100 μm, preferably greater than about 200 μm; and less than about 3 mm, preferably less than about 1 mm, more preferably less than about 500 μm (or any thickness or thickness range between about 100 μm and 3 mm in increments of 1 μm).

Further, although not shown in the figures, any of the herein-described nozzles 10 may further comprise one or more alignment surface features that enable (1) alignment of nozzle 10 (i.e., in the x-y plane) relative to a fuel injector 101 and (2) rotational alignment/orientation of nozzle 10 (i.e., a proper rotational position within the x-y plane) relative to a fuel injector 101. The one or more alignment surface features aid in positioning nozzle 10 and nozzle through-holes 15 therein so as to be accurately and precisely directed at one or more target location lₜ as discussed above. The one or more alignment surface features on nozzle 10 may be present along inlet face 11, outlet face 14, periphery 19, or any combination of inlet face 11, outlet face 14 and periphery 19. Further, the one or more alignment surface features on nozzle 10 may comprise, but are not limited to, a visual marking, an indentation within nozzle 10, a raised surface portion along nozzle 10, or any combination of such alignment surface features.

It should be understood that although the above-described nozzles, nozzle plates, fuel injectors, fuel injector systems, and methods are described as “comprising” one or more components, features or steps, the above-described nozzles, nozzle plates, fuel injectors, fuel injector systems, and methods may “comprise,” “consists of,” or “consist essentially of” any of the above-described components and/or features and/or steps of the nozzles, nozzle plates, fuel injectors, fuel injector systems, and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a nozzle, nozzle plate, fuel injector, fuel injector system, and/or method that “comprises” a list of elements (e.g., components or features or steps) is not necessarily limited to only those elements (or components or features or steps), but may include other elements (or components or features or steps) not expressly listed or inherent to the nozzle, nozzle plate, fuel injector, fuel injector system, and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a nozzle, nozzle plate, fuel injector, fuel injector system, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described nozzles, nozzle plates, fuel injectors, fuel injector systems, and/or methods may comprise, consist essentially of, or consist of any of the herein-described components and features, as shown in the figures with or without any additional feature(s) not shown in the figures. In other words, in some embodiments, the nozzles, nozzle plates, fuel injectors, fuel injector systems, and/or methods of the present invention may have any additional feature that is not specifically shown in the figures. In some embodiments, the nozzles, nozzle plates, fuel injectors, fuel injector systems, and/or methods of the present invention do not have any additional features other than those (i.e., some or all) shown in the figures, and such additional features, not shown in the figures, are specifically excluded from the nozzles, nozzle plates, fuel injectors, fuel injector systems, and/or methods.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

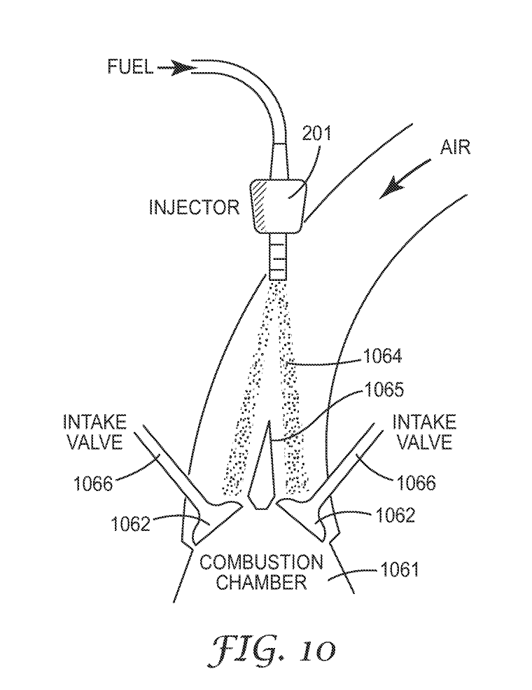

Nozzles, similar to exemplary nozzles 10 as shown in FIGS. 1, 3A-7 and 9-10, were prepared for use in fuel injector systems, similar to fuel injector system 100.

From the above disclosure of the general principles of the present invention and the preceding detailed description, those skilled in this art will readily comprehend the various modifications, re-arrangements and substitutions to which the present invention is susceptible. Therefore, the scope of the invention should be limited only by the following claims and equivalents thereof. In addition, it is understood to be within the scope of the present invention that the disclosed and claimed nozzles may be useful in other applications (i.e., not as fuel injector nozzles). Therefore, the scope of the invention may be broadened to include the use of the claimed and disclosed structures for such other applications.

1. A fuel injector nozzle comprising:
an inlet face;
an outlet face opposite said inlet face; and
nozzle through-holes, with each nozzle through-hole comprising at least one inlet opening on said inlet face connected to at least one outlet opening on said outlet face by a cavity defined by an interior surface, said inlet opening being larger than said outlet opening, and fuel flowing out of said outlet opening is directed at an acute or obtuse angle from said outlet face and toward at least one target location a desired distance from said outlet face,
wherein fuel flowing out of a plurality of said through-holes form fuel streams that focus to a single target location a desired distance from said outlet face.

2. The nozzle of claim 1, wherein at least one said nozzle through-hole has an inlet opening axis of flow, a cavity axis of flow and an outlet opening axis of flow, and at least one axis of flow is different from at least one other axis of flow.

3. The nozzle of claim 2, wherein at least one said nozzle throughhole has multiple inlet openings, multiple outlet openings or both, with an axis of flow corresponding to each of said multiple openings.

4. The nozzle of claim 1, wherein said nozzle is a nozzle plate having a substantially flat configuration.

5. The nozzle of claim 1, wherein said at least one target location is an intake valve for a combustion chamber of an internal combustion engine.

6. The nozzle of claim 1, wherein said at least one target location is at least two intake valves for a combustion chamber of an internal combustion engine.

7. The nozzle of claim 6, wherein the at least two intake valves are separated by at least one barrier and fuel flowing out of said through-holes is directed on opposite sides of said at least one barrier.

8. The nozzle of claim 1, wherein said inlet face is a non-coined three-dimensional inlet face, said inlet face comprises a seating surface for receiving so as to form a seal with a fuel injector valve, and when the fuel injector valve forms a seal with said seating surface, a SAC volume is defined between said inlet face and the fuel injector valve.

9. The nozzle of claim 8, wherein said inlet face further comprises one or more inlet face features that extend into a ball valve outlet region of a fuel injector system so as to reduce the SAC volume.

10. A fuel injector comprising the nozzle of claim 1.

11. A fuel injection system of a vehicle comprising the fuel injector of claim 10.

12. The fuel injection system of claim 11, said fuel injection system having a reduced SAC volume, said reduced SAC volume being less than about 1.0 mm³.

13. An internal combustion engine comprising:
one or more intake valves, each of which comprising an intake valve stem; and
the fuel injection system of claim 11;
wherein said nozzle directs fuel at each intake valve stem.

14. A method of making the nozzle of claim 1.

15. A method of reducing a SAC volume of a fuel injection system of a vehicle, said method comprising incorporating a nozzle into the fuel injection system, wherein one or more inlet face features of the nozzle extend into a ball valve outlet region of a fuel injector system so as to reduce the SAC volume.

16. The nozzle of claim 4, wherein said at least one target location is an intake valve for a combustion chamber of an internal combustion engine.

17. The nozzle of claim 4, wherein said at least one target location is at least two intake valves for a combustion chamber of an internal combustion engine.

18. The nozzle of claim 4, wherein said inlet face is a non-coined three-dimensional inlet face, said inlet face comprises a seating surface for receiving so as to form a seal with a fuel injector valve, and when the fuel injector valve forms a seal with said seating surface, a SAC volume is defined between said inlet face and the fuel injector valve.

19. A fuel injector comprising the nozzle of claim 18.

20. The fuel injector of claim 19 having a reduced SAC volume of less than about 1.0 mm³.
